(19) United States
(12) Patent Application Publication
(10) Pub. No.: US 2004/0037211 A1
(43) Pub. Date: Feb. 26, 2004

(54) Optical information recording medium having phase pit array

(75) Inventors: Takanobu Higuchi, Tsurugashima-shi (JP); Takayuki Nomoto, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/620,436

(22) Filed: Jul. 17, 2003

(30) Foreign Application Priority Data
Aug. 26, 2002 (JP) 2002-245135

(51) Int. Cl. G11B 7/24

(52) U.S. Cl. 369/275.4

(57) ABSTRACT

The present invention provides an optical information recording medium with favorable signal reproduction characteristics that comprises a substrate, a reflective layer and a protective layer, and performs playback by allowing a laser beam for signal playback to enter via the protective layer, wherein the substrate is provided with a phase pit array for holding information. Each phase pit of the phase pit array is formed as a cavity which is reentrant as viewed from the entrance side of the signal playback laser beam.

### BACKGROUND OF THE INVENTION

1. Field of the Invention

The present invention relates to an optical information recording medium such as an optical disk.

2. Description of the Related Art

As optical information recording media, optical disks such as CDs and DVDs are known. As shown in FIG. 1, an optical disk 1 comprises a substrate 2 that comprises a recording surface 3 on which a phase pit array (not shown) holding information is provided. A reflective layer 4 comprising Al or similar is stacked on the recording surface 3. A protective layer 5 comprising a resin that protects the reflective layer is stacked on the reflective layer 4. A center hole 6 that passes through the disk is provided in the center of the optical disk 1.

The optical disk 1 is mounted on a rotatable turntable (not shown) provided with a member that mates with the center hole 6 and is turned while information held in the pit array is read by means of an optical pickup 7. The optical pickup 7 comprises a semiconductor laser 9 that emits a coherent laser beam 8. The laser beam 8 is transmitted by a collimator lens 10, a beam splitter 11 and an objective lens 12 in this order. The laser beam 8 condensed by the objective lens 12 enters via the substrate side of the optical disk 1. The laser beam 8, having thus entered via the substrate 2, is reflected by the reflective layer 4 and thus travels in a direction that is the reverse of the direction of incidence. The reflected laser beam travels through the objective lens 12 and the beam splitter 11, the direction of travel thereof being changed by the beam splitter 11 to a direction perpendicular to the laser optical axis such that light is received by a detector 14 via a condenser lens 13. The detector 14 converts the received laser beam into an electrical signal. The electrical signal undergoes signal processing by a signal processing circuit (not shown), whereby information held by a pit array is played back.

As is common knowledge, an optical disk such as a DVD or CD is obtained by molding a thermoplastic polymer such as a polycarbonate using a stamper which is obtained by additional plating on a metal layer deposited on the original recording surface of an optical disk. In the molding, pits on the stamper are protrusions with respect to the reference face of the stamper so that no air remains in the mold when the molten polymer flows into the mold.

Therefore, as is also evident from the enlarged perspective view of FIG. 2, it is clear that, in the case of the conventional optical disk shown in FIG. 1, the phase pits 15 of the recording surface 3 of the substrate 2 comprising thermoplastic polymer are recesses as viewed from the reference plane of the recording surface 3, and that when reading takes place by means of a reading beam 8 that passes through the substrate 2, the phase pits 15 are protrusions as viewed from the reading beam entrance side.

This aspect is also evident from FIG. 3 that shows a cross-section of the optical disk 1 in FIG. 1. Stated differently, the phase pits 15 are formed as cavities with respect to the reference plane of the recording surface 3 of the substrate 2. In the laser beam reflected at the interface between the recording surface 3 and the reflective layer 4, the laser beam reflected by the phase pits 15 generates diffraction. As a result, the reflected light reflected at the phase pits 15 is small in comparison with the reflected light reflected in sections where the phase pits 15 are not provided. This variation in the amount of reflected light constitutes the signal output from the detector 14. This signal is processed by the signal processing circuit (not shown), whereby the original information is played back.

In cases where an optical disk provided with phase pits constituting protrusions as viewed from the reading beam entrance side is played back by a playback device that employs an objective lens with a low numerical aperture, the information held by the phase pits and the information played back by the information playback device match regardless of the size of the phase pits. However, when a playback device comprising an objective lens with a high numerical aperture is used with the object of increasing the capacity of the optical disk, there is no match between information held by phase pits that are small in size and the information which is played back from these phase pits by the playback device.

An example is shown in FIG. 4. FIG. 4 shows a playback waveform when a protrusion pit array modulated from 1 to 7 with a track pitch of 320 nm and a minimum pit length of 149 nm is played back using an objective lens with a numerical aperture of 0.85 and a reading laser beam with a wavelength of 405 nm. It is understood from this playback signal waveform example that the center level L₀ of an eye pattern (shown with bold lines) for pits having a pit length 2T is low in comparison with the center level of an eye pattern for pits of another length. This level drop is due to the influence of the increased polarization resulting from the large numerical aperture of the objective lens. As a result of this influence, phase pits are detected as being larger than in reality and the shorter the pit length, the more marked the detection of errors becomes.

Although the formation of small phase pits is effective in resolving this phenomenon, the act of further reducing the minimum pit which is the 2T pit that is 149 nm and adequately short, for example, proves problematic in the creation of the disk.

The above example is cited as one example of the problems which the present invention is intended to resolve.

### SUMMARY OF THE INVENTION

The optical information recording medium according to a first aspect of the present invention is an optical information recording medium, comprising: a substrate comprising a recording surface provided with a phase pit array for holding information; a reflective layer formed on the recording surface; and a protective layer formed on the reflective layer, wherein each phase pit of the phase pit array is a cavity which is reentrant as viewed from the entrance side of a reading laser beam.

The optical information recording medium according to another aspect of the present invention is an optical information recording medium, comprising: a substrate comprising a recording surface provided with a phase pit array for holding information; a reflective layer formed on the recording surface; and a protective layer formed on the reflective layer, this medium being played back by a reading beam that is a short wavelength laser beam emitted via an optical system with a high numerical aperture, wherein each phase pit of the phase pit array is a cavity which is reentrant as viewed from the entrance side of the short wavelength laser beam.

### BRIEF DESCRIPTION OF THE DRAWINGS

FIG. 1 is a side view showing a conventional optical disk and optical pickup;

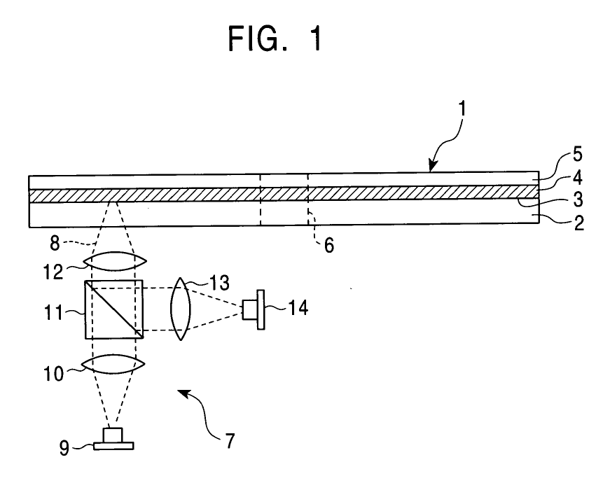

FIG. 2 is an enlarged partial perspective view of the conventional optical disk;

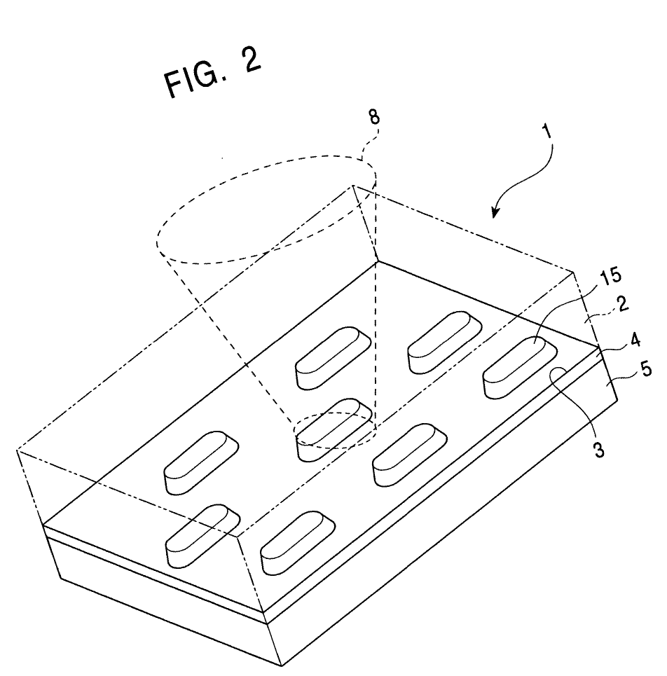

FIG. 3 is an enlarged partial cross-sectional view of the conventional optical disk;

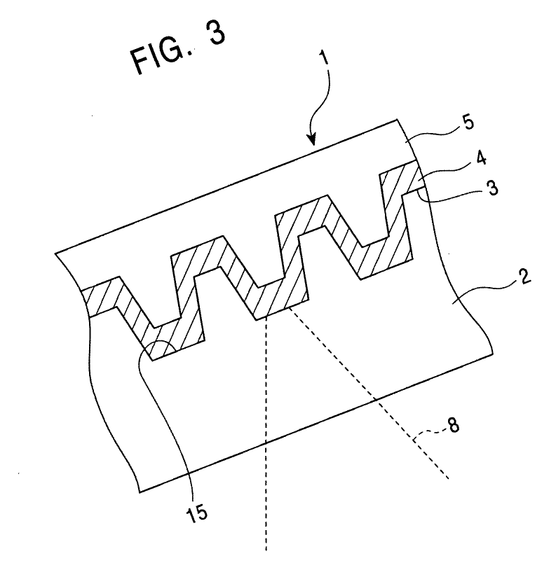

FIG. 4 is a graph showing a playback signal waveform of the conventional optical disk;

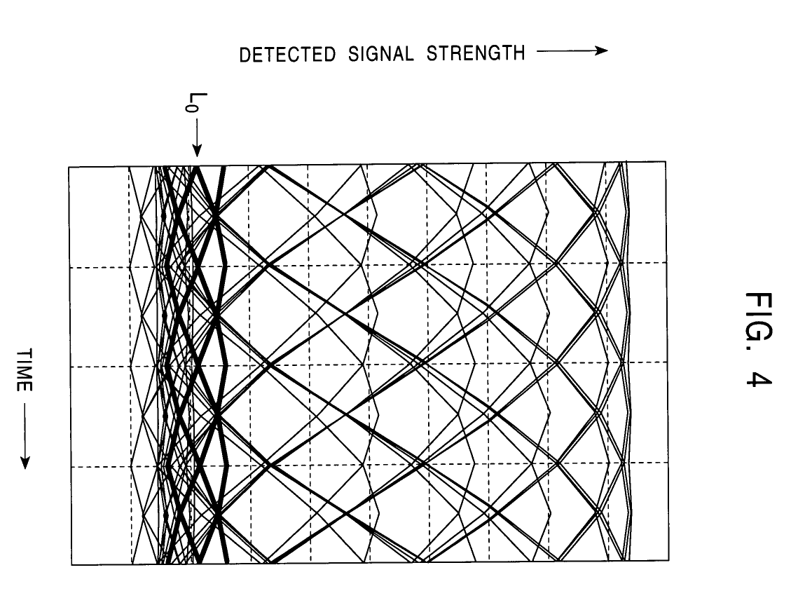

FIG. 5 is an enlarged partial perspective view of the optical disk according to the present invention;

FIG. 6 is an enlarged partial cross-sectional view of the optical disk according to the present invention;

FIG. 7 is a cross-sectional view showing a sputtering method for the optical disk according to the present invention;

FIG. 8 is a graph showing a playback signal waveform of the optical disk according to the present invention; and

FIG. 9 is a graph showing playback jitter of the conventional optical disk and of the optical disk according to the present invention.

### DETAILED DESCRIPTION OF THE INVENTION

Embodiments of the present invention will now be described in detail with reference to the attached drawings.

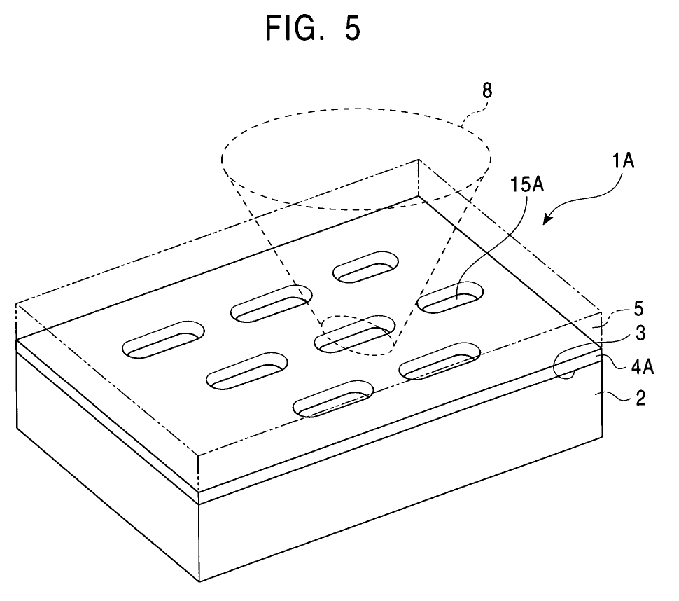

As shown in FIG. 5, an optical disk 1A according to the present invention comprises a substrate 2 comprising a recording surface 3 provided with an array of phase pits 15A for holding information. Each of the phase pits 15A of the phase pit array is a cavity which is reentrant as viewed from the entrance side of the laser beam 8.

A reflective layer 4A for reflecting the laser beam 8 is provided on the recording surface 3. A protective layer 5 comprising resin is provided on the reflective layer 4A. The thickness of the protective layer 5 is preferably 0.1±0.03 mm.

When recorded information of the optical disk 1A according to the present invention is played back, information held by the phase pit array of the recording surface 3 can be read by allowing a laser beam 8 to enter the surface of the reflective layer 4A via the protective layer 5 and by detecting, by means of an optical pickup (not shown), the laser beam reflected by the reflective layer 4A.

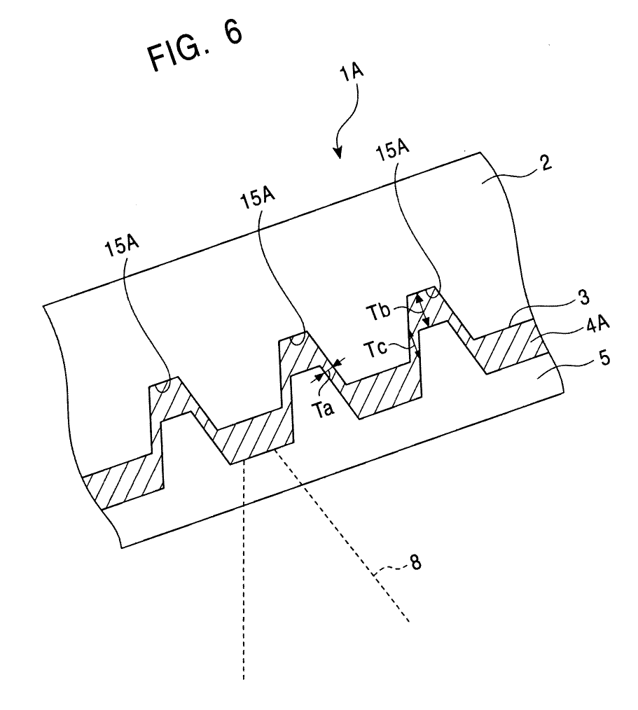

As shown in FIG. 6, the phase pits 15A are cavities which are reentrant in the substrate 2 as viewed from the entrance side of the laser beam 8. Further, the laser beam 8 is reflected by the reflective layer 4A. If the cross-sectional shape of the reflective layer 4A is not the same as the cross-sectional shape of the phase pits 15A, accurate information playback cannot be achieved. Therefore, the thickness of the reflective layer 4A is preferably thinner at the inner surface of the recesses of the phase pits 15A than in other parts. When the thickness Tₐ of the inner surface of the phase pits 15A and the thickness T_{b} of the bottom of the phase pit 15A are compared, the thickness T_{b} of the bottom is larger (Tₐ<T_{b}) Because the thickness of the inner surface of the recesses of the phase pits 15A is less than the thickness of other parts, the uneven shape of the surface of the reflective layer 4A onto which the reading laser beam 8 for the reflective layer 4A falls incident can be made equal to the uneven shape of the recording surface 3.

Stated differently, the reflective layer 4A is desirably of a thickness that is substantially the same in the direction perpendicular to the principal plane of the substrate 2. In other words, the thickness (T_{c}) in the direction perpendicular to the principal plane of the inside wall face of the phase pits 15A, and the thickness (T_{b}) in the direction perpendicular to the principal plane of the bottom face of the phase pits 15A can be made substantially the same (T_{c}≠T_{b}).

Sputtering, for example, can be employed in order to form a reflective layer that is thinner in the inner surface of the recesses of the phase pit array than in other parts as described above.

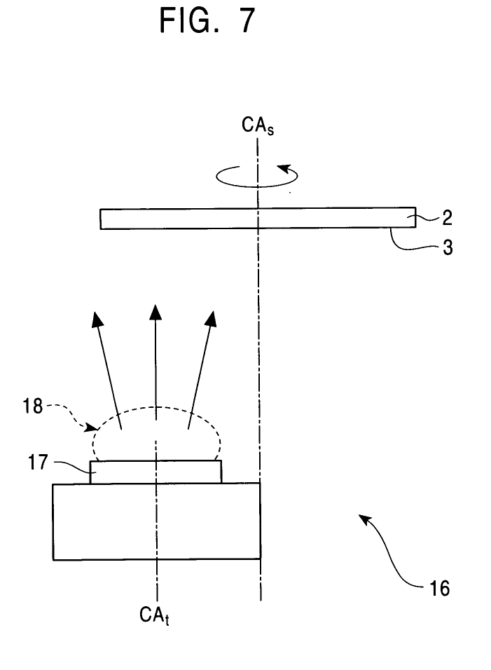

In cases where sputtering is indeed used to form the reflective layer, a sputter device like that shown in FIG. 7 can be employed. A sputter device 16 is such that a target 17 that is smaller in size than the substrate 2, and the substrate 2 are separated by a distance equal to or more than 30 mm (100 mm, for example), the center axis (CAₜ) of the target 17 is eccentric with respect to the center axis (CAₛ) perpendicular to the principal plane of the substrate 2, and the recording surface 3 and the target 17 are made to face one another. Next, when a rotation device (not shown) is used to turn the substrate 2 about the center axis (CAₛ) of the substrate 2 while the target 17 is made to perform sputtering, the sputtered target material flies from the plasma 18 in a manner substantially parallel to the center axis CAₛ, of the substrate (substantially perpendicular to the principal plane of the substrate). In consequence, it is possible to form the reflective layer 4A in a thickness that is substantially equal in the direction of the center axis (CAₛ) of the substrate.

Further, the material used for the reflective layer 4A can be an alloy of which the principal component is Al that comprises at least one of Ti, Cr, Zn, Mn, Cu, Pd, Mg, and Si. When such an alloy is used, the reflective layer 4A preferably has a thickness of less than 14 nm in the direction perpendicular to the principal plane of the substrate 2.

In addition to the above material, it is possible to employ an alloy of which the principal component is Ag that comprises at least one of Ti, Cu, Pd, Si, and Sn for the reflective layer 4A. In this case, the reflective layer 4A preferably has a thickness of less than 20 nm in the direction perpendicular to the principal plane of the substrate 2.

The optical disk according to the present invention can be played back by a playback device that emits a short wavelength laser beam as a reading beam via an optical system with a high numerical aperture. The optical system with a high numerical aperture comprises an objective lens with a numerical aperture of 0.80 or more, for example. The short wavelength laser beam is, for example, a laser beam with a wavelength of 405±5 nm.

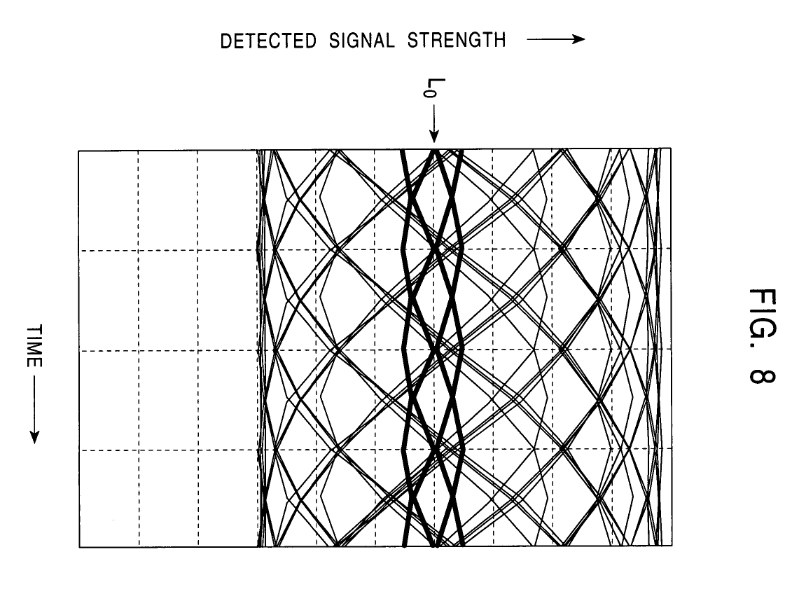

FIG. 8 is a graph showing a measurement example for a playback signal waveform obtained in a case of playing back the optical disk according to the present invention provided with pits that have pit lengths 2T to 8T (pit length 2T is 149 nm) by means of a playback device that emits a reading beam by passing a laser beam with a wavelength of 405 nm via an objective lens with a numerical aperture of 0.85. The center level Lₒ of an eye pattern (bold lines) for pits of pit length 2T substantially matches the center of an eye pattern for pits of another pit length. In other words, a playback signal holding accurate information may be obtained because the uneven shape of the phase pit array is correctly detected regardless of the size of the phase pits as a result of providing the phase pits as recesses as viewed from the reading beam side.

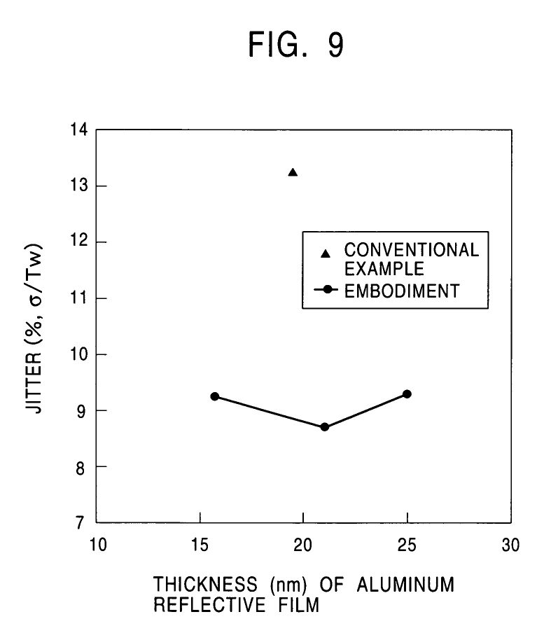

FIG. 9 shows a measurement example of playback jitter of a playback signal obtained through playback by means of a playback device that comprises an objective lens with a numerical aperture of 0.85 and a laser light source with a wavelength of 405±5 nm by providing optical disks, namely an optical disk provided with phase pits in the form of recesses as viewed from the light source side, and an optical disk provided with phase pits in the form of protrusions, with a pit array in which the shortest pit length is 0.159 μm and the track pitch is 0.30 μm. In the case of the optical disk provided with phase pits in the form of recesses as viewed from the light source side, the jitter is lower than that of the optical disk in which phase pits are provided in the form of protrusions. In other words, by providing the phase pits in the form of recesses as viewed from the light source side, a drop in signal playback performance is not readily generated during playback even when a playback device that comprises an optical system with a high numerical aperture and a short wavelength laser light source is employed.

An evaluation was made using AlTi (Al:Ti=99:1) as the material of the reflective layer 4A, and an optical disk of which the thickness in the direction perpendicular to the principal plane of the substrate 2 is 8 nm (shortest pit length: 149 nm, and track pitch: 320 nm). The reflectance of this optical disk was 18.6%, and the playback jitter of this optical disk was 7.5%.

As a modified example, an optical disk was formed in which the material of the reflective layer 4A was AgPdCu (Ag:Pd:Cu=98.1:0.9:1.0) and the thickness in the direction perpendicular to the principal plane of the substrate 2 was 17 nm. The reflectance of this optical disk was 17.8% and the playback jitter of this optical disk was 7.1%.

Further, in cases where the reflectance of the reading laser beam of the optical disk 1A of the present invention is subjected to modulation according to the phase pit during signal playback, the reflectance desirably has a maximum value in the range of at least 10% and no more than 25%. If this is achieved, compatibility with existing optical disks is obtained that matches the reflectance ranges recommended for recordable optical disks and rewritable optical disks.

If the optical information recording medium is an optical information recording medium that comprises a substrate comprising a recording surface provided with a phase pit array for holding information, a reflective layer formed on the recording surface, and a protective layer formed on the reflective layer, wherein each phase pit of the phase pit array is a cavity which is reentrant as viewed from the entrance side of the reading laser beam, even in a case of reading information by means of a reading beam that passes through an objective lens with a high numerical aperture, information recorded by the phase pit array provided on the optical disk can be correctly detected.

Moreover, in the case of an optical information recording medium that comprises a substrate comprising a recording surface provided with a phase pit array for holding information, a reflective layer formed on the recording surface, and a protective layer formed on the reflective layer, this medium being played back by a reading beam that is a short wavelength laser beam emitted via an optical system with a high numerical aperture, wherein each phase pit of the phase pit array is a cavity which is reentrant as viewed from the entrance side of the short wavelength laser beam, the recorded information reproduction characteristics are favorable even for a playback device that comprises an optical system with a high numerical aperture and a short wavelength light source.

This application is based on Japanese Patent Application No. 2002-245135 which is herein incorporated by reference.

What is claimed is:

1. An optical information recording medium, comprising:
a substrate comprising a recording surface provided with a phase pit array for holding information;
a reflective layer formed on the recording surface; and
a protective layer formed on the reflective layer,
wherein each phase pit of the phase pit array is a cavity which is reentrant as viewed from the entrance side of a reading laser beam.

2. The optical information recording medium according to claim 1, wherein the thickness of the reflective layer is less in the inner face of the recess of each phase pit of the phase pit array than in other parts.

3. The optical information recording medium according to claim 2, wherein the reflective layer extends over the recording surface and has substantially the same thickness in the direction perpendicular to the principal plane of the substrate.

4. The optical information recording medium according to claim 1, wherein the thickness of the protective layer is 0.1±0.03 mm.

5. The optical information recording medium according to claim 1, wherein the reading laser beam is a laser beam with a wavelength of 405±5 nm that passes through an objective lens with a numerical aperture of 0.80 or more.

6. The optical information recording medium according to claim 5, wherein the maximum value of the reflectance of the reflective layer with respect to the reading laser beam that is subjected to modulation according to the phase pit is in the range of at least 10% and no more than 25%.

7. The optical information recording medium according to claim 1, wherein the reflective layer comprises an alloy of which the principal component is Al that comprises at least one of Ti, Cr, Zn, Mn, Cu, Pd, Mg, and Si, and the thickness of the reflective layer is less than 14 nm in the direction perpendicular to the principal plane of the substrate.

8. The optical information recording medium according to claim 1, wherein the reflective layer comprises an alloy of which the principal component is Ag that comprises at least one of Pd, Ti, Cu, Si, and Sn, and the thickness of the reflective layer is less than 20 nm in the direction perpendicular to the principal plane of the substrate.

9. An optical information recording medium, comprising:
a substrate comprising a recording surface provided with a phase pit array for holding information;
a reflective layer formed on the recording surface; and
a protective layer formed on the reflective layer,
this medium being played back by a reading beam that is a short wavelength laser beam emitted via an optical system with a high numerical aperture,
wherein each phase pit of the phase pit array is a cavity which is reentrant as viewed from the entrance side of the short wavelength laser beam.

10. The optical information recording medium according to claim 9, wherein the numerical aperture of the optical system is equal to or more than 0.80.

11. The optical information recording medium according to claim 9, wherein the short wavelength laser beam has a wavelength of 405±5 nm.

12. The optical information recording medium according to claim 9, wherein the thickness of the reflective layer is less in the inner face of the recess of each phase pit of the phase pit array than in other parts.

13. The optical information recording medium according to claim 12, wherein the reflective layer has substantially the same thickness over the recording surface in the direction perpendicular to the principal plane of the substrate.

14. The optical information recording medium according to claim 9, wherein the thickness of the protective layer is 0.1±0.03 mm.

15. The optical information recording medium according to claim 9, wherein the maximum value of the reflectance of the reflective layer with respect to the short wave laser beam that is subjected to modulation according to the phase pit is in the range of at least 10% and no more than 25%.

16. The optical information recording medium according to claim 9, wherein the reflective layer comprises an alloy of which the principal component is Al that comprises at least one of Ti, Cr, Zn, Mn, Cu, Pd, Mg, and Si, and the thickness of the reflective layer is less than 14 nm in the direction perpendicular to the principal plane of the substrate.

17. The optical information recording medium according to claim 9, wherein the reflective layer comprises an alloy of which the principal component is Ag that comprises at least one of Pd, Ti, Cu, Si, and Sn, and the thickness of the reflective layer is less than 20 nm in the direction perpendicular to the principal plane of the substrate.
